(19) United States
(12) Patent Application Publication
(10) Pub. No.: US 2010/0231041 A1
(43) Pub. Date: Sep. 16, 2010

(54) EFFICIENT DC DISTRIBUTION SYSTEM, TOPOLOGY, AND METHODS

(76) Inventors: Bill Koehler, Saylorsburg, PA (US); Donald Mulvey, Stroudsburg, PA (US)

Correspondence Address: MERLE W. RICHMAN, III, P.O. BOX 3333, LA JOLLA, CA, 92038, US

(21) Appl. No.: 12/788,188

(22) Filed: May 26, 2010

Related U.S. Application Data
(63) Continuation-in-part of application No. 11/777,646, filed on Jul. 13, 2007.

(51) Int. Cl. H02J 1/00

(52) U.S. Cl. 307/31

(57) ABSTRACT

Embodiments of power distribution systems and methods are described generally herein. Other embodiments may be described and claimed.

### CROSS REFERENCE TO RELATED APPLICATIONS

The present application is related to co-pending application Ser. No. 11/777,646, Attorney Docket RE002US, entitled “EFFICIENT DC DISTRIBUTION SYSTEM, TOPOLOGY, AND METHODS”, filed Jul. 13, 2007, which is incorporated herein by reference.

### TECHNICAL FIELD

Various embodiments described herein relate to low voltage direct current (DC) devices supplied by high voltage direct current sources and AC power sources.

### BACKGROUND INFORMATION

FIG. 1 is a block diagram of prior art architecture 10 that includes several DC power based devices (solid state lighting (SSL) fixtures 16, 18, 36, 38). In this architecture 10, each DC device (SSL fixture) 16, 18, 36, 38 includes or is coupled to an AC to DC power converter 32. Each AC to DC power converter 32 may be coupled to an alternating current (AC) power supply or source and may convert the AC signal or power to a DC signal having the signal requirements for a corresponding DC device 16, 18, 36, 38. In architecture 10 an electrician may be required to connect an AC signal to each AC to DC converter 32 depending on electrical codes. The AC to DC converter 32 may be located in close proximity to each DC device 16, 18, 36, 38, e.g., within the same room or less than a predetermined maximum distance from a fixture. The AC to DC converter 32 may also be housed with the DC device. The present invention provides a more efficient system, topology, and method for supplying DC power to two or more DC power based devices versus requiring a power converter 32 for each DC device 16, 18, 36, and 38.

### BRIEF DESCRIPTION OF THE DRAWINGS

FIG. 1 is a block diagram of a prior art power distribution architecture.

FIG. 2A is a block diagram of a power distribution architecture according to various embodiments.

FIG. 2B is a block diagram of another power distribution architecture according to various embodiments.

FIG. 2C is a block diagram of a multiple HPDC source distribution architecture according to various embodiments.

FIG. 2D is a block diagram of another power distribution architecture according to various embodiments.

FIG. 3 is a flow diagram illustrating several methods according to various embodiments.

FIG. 4 is a flow diagram illustrating several methods according to various embodiments.

FIG. 5A is a block diagram of a LPDC splitter according to various embodiments.

FIG. 5B is a block diagram of another LPDC splitter according to various embodiments.

FIG. 6A is a block diagram of another LPDC splitter according to various embodiments.

FIG. 6B is a block diagram of a multiple channel LPDC splitter according to various embodiments.

FIG. 7 is a block diagram of an article according to various embodiments.

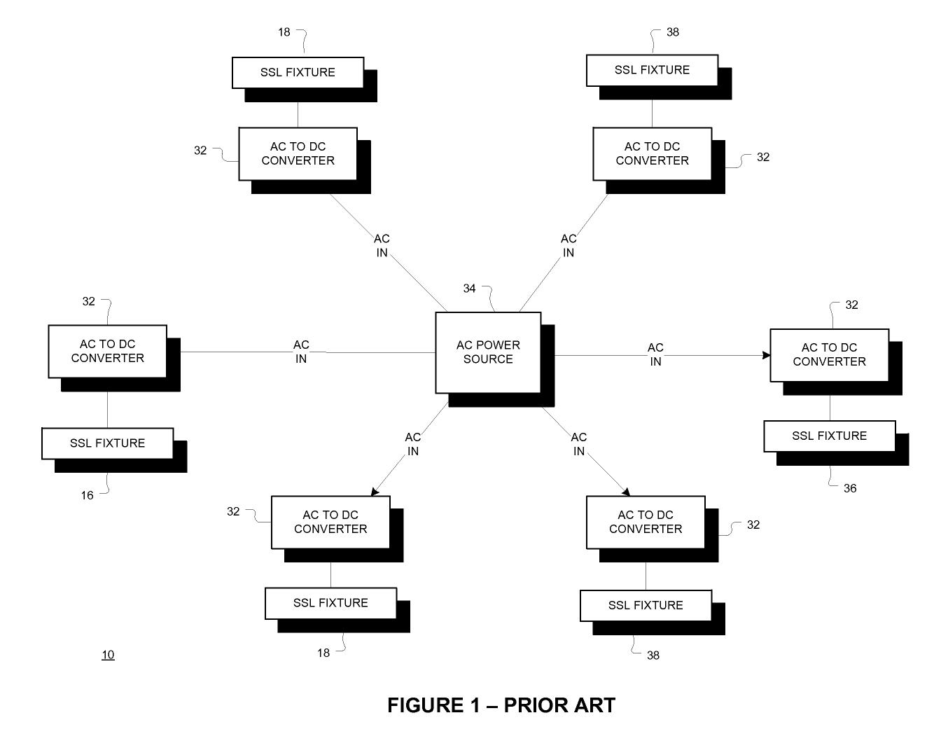

### DETAILED DESCRIPTION

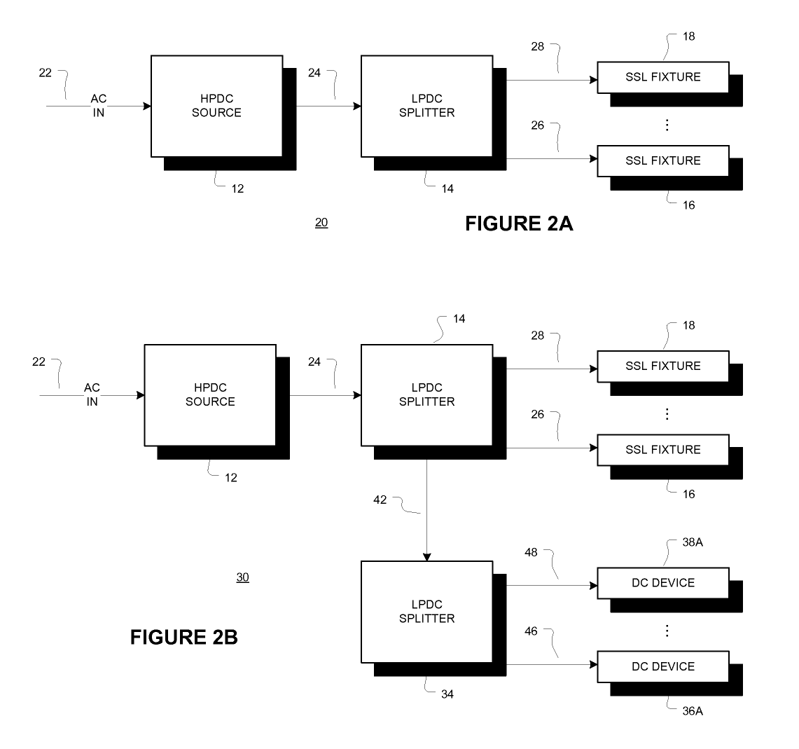

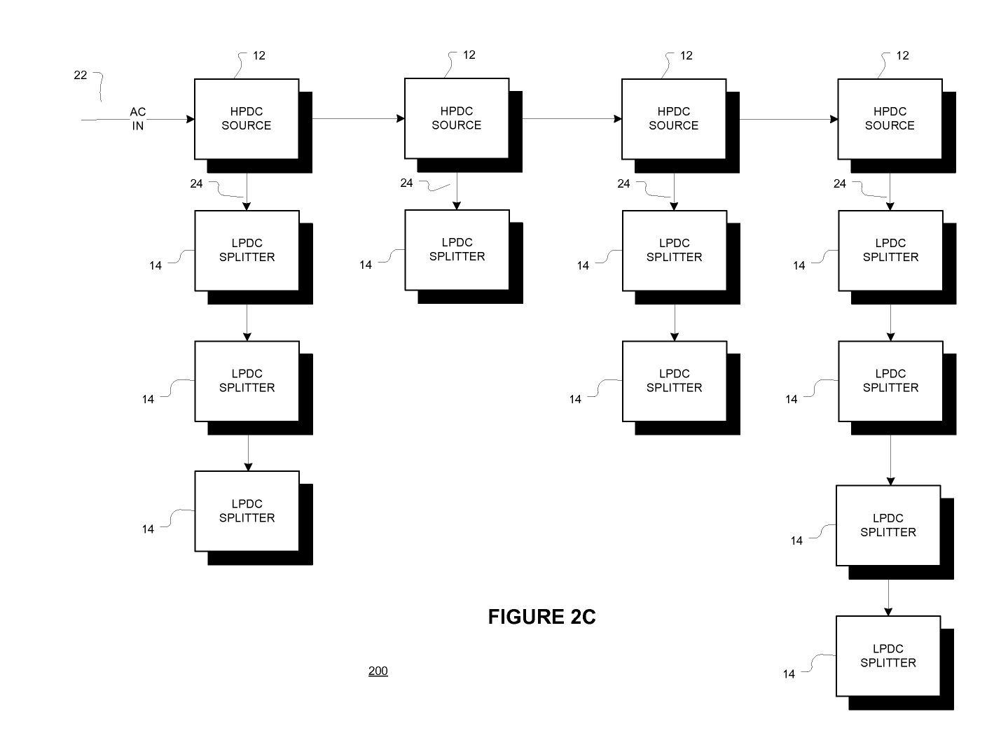

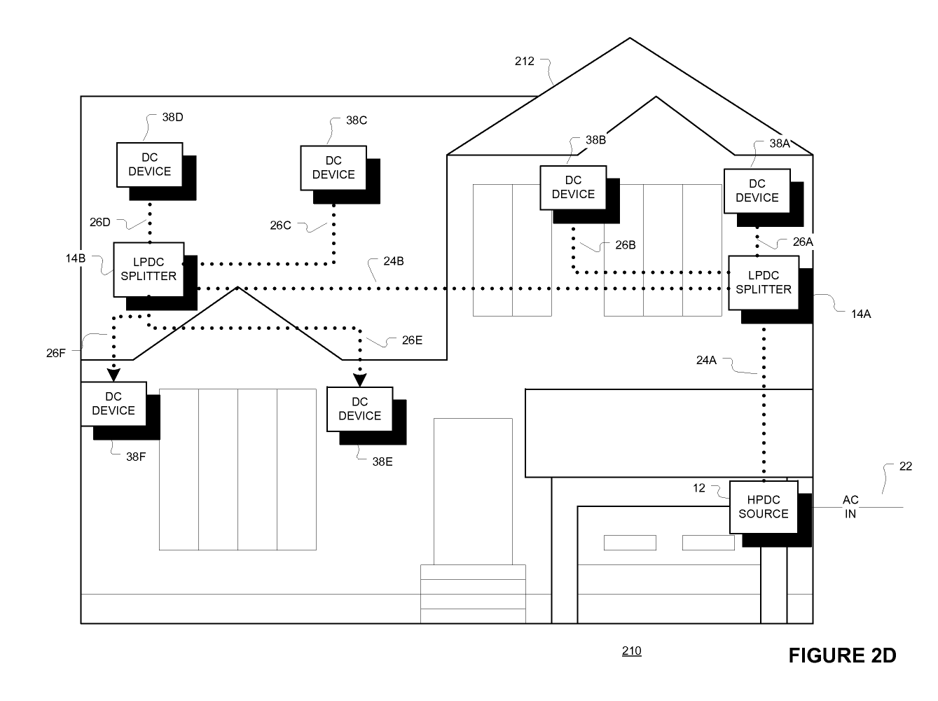

FIG. 2A is a block diagram of a direct current (DC) power distribution architecture 20 according to various embodiments. The architecture 20 includes a high power DC (HPDC) source-converter 12, a low power DC (LPDC) splitter 14, and two or more DC powered devices 16, 18. In an embodiment, a DC powered device may an device requiring direct current energy including a solid state lighting (SSL) fixture including a Light Emitting Diode (LED), electro-luminance (EL), or other low voltage DC lighting device. An LED fixture may include a LED lighting strip, lighting tile, lighting unit, module, array, channel letter sign kit, channel light, border light kit, channel letter lighting system, border tube kit, Class 2 lighting system, Class 2 lighting assembly, Class 2 lighting strip, Class 2 illumination module, or Class 2 fixture.

In an embodiment, a HPDC source 12 may include an alternating current (AC) to DC converter including a diode bridge or other devices to convert an AC signal to a DC signal. The HPDC source 12 may receive an AC signal 22 and generate an electrical signal 24 having substantially DC energy. The HPDC source-converter 12 may also limit one of the current, voltage, and wattage of the electrical signal 24 in an embodiment. The HPDC may provide the electrical signal 24 to one or more LPDC splitters (FIG. 2A, 2B). A LPDC splitter 14 may generate one or more low power DC (LPDC) electrical signals 26, 28 for two or more DC powered devices (SSL fixtures 16, 18).

In an embodiment, a HPDC converter-source 12 may generates Class 1 signals 24 and a LPDC splitter 14 may generate Class 2 signals 26, 28 as defined by the National Electric Code (NEC) Article 725. The NEC, Article 725 defines: a) Class 1: signals having a maximum of 30 volts and 1,000 volt-amperes; and Class 2: signals having a maximum of 30 volts, 100 volt-amperes, and 8 amperes. In general Class 2 electrical signals are not considered a danger to personnel. Depending on electrical codes, an electrician may not be required to install wiring conducting Class 2 signals, e.g., signals between a LPDC splitter 14 and a DC powered device 16, 18.

In an embodiment a HPDC source 12 may be a large distance from the LPDC splitter 14 (e.g., up to 200 feet), in an embodiment. Similarly, a DC device 16, 18 may be located a large distance from a LPDC splitter 14, in an embodiment up to 100 feet. Accordingly, a LPDC splitter 14 may be located at a central location relative to the two or more fixtures 16, 18 and a further distance to a HPDC converter-source 12.

In an embodiment, a HPDC source 12 or a LPDC splitter 14 may conform to other standards. In an embodiment, a HPDC converter-source 12 maximum volt-amperes signal level may be at a multiple of coupled LPDC splitters 14 maximum volt-amperes signal level (e.g. 2 or 4 times greater). FIG. 2B is a block diagram of another power distribution architecture 30 according to various embodiments. The architecture 30 includes a HPDC converter-source 12, a first LPDC splitter 14 coupled to at least two fixtures 16, 18, and a second LPDC splitter 34 coupled to at least two fixtures 36, 38 and the first LPDC splitter 14. In this embodiment, the first LPDC splitter 14 provides an electrical signal to the DC devices 16, 18 and the second LPDC splitter 34. In another embodiment, a HPDC converter-source 12 may provide power to a first and a second LPDC splitter 14, 34.

FIG. 2C is a block diagram of a power distribution architecture 200 according to various embodiments. In architecture 200, a HPDC source 12 may include a pass through port for a received AC signal. In architecture 200, several HPDC converters-sources 12 may be employed to provide a substantially DC signals to several LPDC splitters 14. As shown in FIG. 2C, four (4) HPDC sources 12 may be coupled to an AC signal 22. Each HPDC converter-source 12 may be electrically coupled to one or more LPDC splitters 14. In architecture 200, a HPDC source 14 is coupled to three (3), one (1), two (2), and four (4) LPDC splitters 14, respectively. Each LPDC splitter 14 may be electrically coupled to one or more DC powered devices. Each HPDC converter-source may be located at a distance of each other HPDC 12 and LPDC 14 (up to 200 feet in an embodiment). Each LPDC splitter 14 may be located at distance from each electrically coupled HPDC converter-source 12 and LPDC splitter 14 (up to 100 feet in an embodiment).

The present invention may be used to employ power distribution networks including at least one LPDC splitter 14, 14A, B. In such an embodiment, a LPDC splitter 14, 14A, B may accept an AC or DC power source signal and convert the signal to LPDC signals for two or more DC powered devices including SSL fixtures. FIG. 2D is a block diagram of a power distribution architecture 210 according to various embodiments. Architecture 210 is employed in a building 212. Architecture 210 includes a HPDC converter-source 12, several LPDC splitters 14A, B, and several DC devices 38A to 38F. The building 212 may receive an AC signal 22 from an external source including an underground or above ground AC source. A HPDC converter-source 12 may be located near the AC signal 22 source to reduce wiring costs.

The HPDC converter-source 12 may generate a high power DC signal 24A and be electrically coupled to at least one LPDC splitter 14A. In an embodiment, the LPDC splitter 14A may be about 20 to 50 feet from the HPDC source 12. The LPDC splitter 14A, B may be electrically coupled to one or more LPDC splitters 14A, B and DC devices 38A-38F. In an embodiment, LPDC splitter 14A may provide a low power DC signal to DC devices 38A, 38B and LPDC splitter 14B. The LPDC splitter 14A may be about 2 to 20 feet from DC device 38A, 38B and from 10 to 100 feet from LPDC splitter 14B. LPDC splitter 14B may provide a low power DC signal to DC devices 38C to 38F. The LPDC splitter 14B may be about 2 to 20 feet from DC devices 38C to 38F.

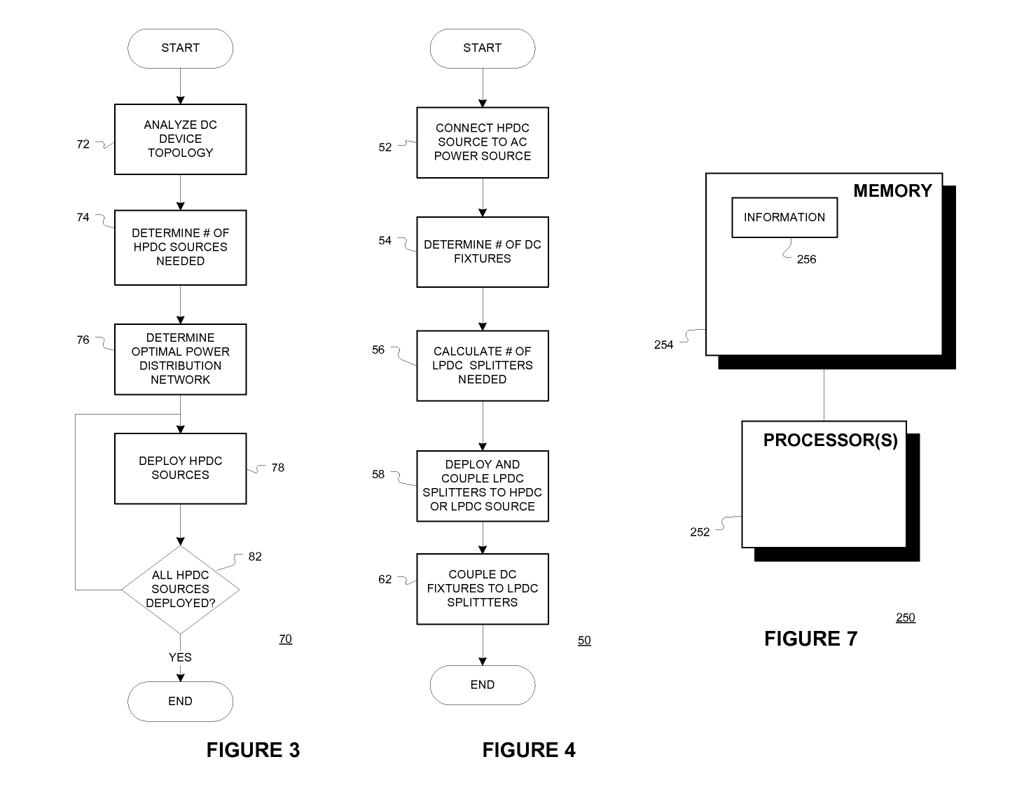

FIG. 3 is a flow diagram illustrating several methods 70 according to various embodiments. In order to determine the optimal or required distribution of HPDC sources 12 and LPDC splitters 14, the method 70 may analyze the desired or existing DC powered device topology in a structure, facility, or location (activity 72). The method may first determine the number of HPDC sources 12 required to support the desired or existing DC powered devices (activity 74). The method may determine the total, maximum power requirement for the DC powered devices and then determine the integer number of HPDC sources needed to support the maximum power requirement based on the HPDC source's 12 maximum power output. The method 70 may also determine the maximum or furthest distance permitted between a HPDC source and one or more LPDC splitters 14 (may be a function of local or national electrical codes). In such an embodiment, additional HPDC sources 12 may be required as a function of the distance between the DC powered devices 16, 18 to be powered.

The method 70 may then determine the optimal power distribution network configuration or topology (activity 76). The location(s) of the required HPDC sources may be determined as a function of the DC powered devices 14, 16 distribution and distance between the ultimate HPDC source(s) 12, LPDC splitters 14, and DC powered devices 16, 18. In an embodiment, the HPDC sources 12 may be located in a central or secure location for safety, security, and local and national electrical code requirements. The method 70 may then deploy the HPDC converters-source(s) and related LPDC splitters 14 (activity 78 and 82) until all the HPDC sources have been deployed.

In some configurations such as for a residential, small business, or small outdoor systems, only a single HPDC source may be required (FIG. 2D). FIG. 4 is a flow diagram illustrating several methods 50 according to various embodiments for powering DC powered devices after HPDC converters-sources have been deployed (algorithm 70). The method 50 may couple one or more HPDC sources 12 to an AC power source (activity 52) or to other HPDC sources (using pass-through ports). The method 50 may then determine the number of DC powered devices in the system topology (activity 54).

The method 50 may determine the total, maximum power requirements for the DC powered devices and then determine the integer number of LPDC splitters needed to support the maximum power requirement based on the LPDC splitter's 14 maximum power output (activity 56). The method 50 may also determine the maximum or furthest distance permitted between a LPDC splitter 14 and a respective or perspective DC powered device 16, 18, 36, 38 where the maximum distance may be determined as a function of local or national electrical codes and economical considerations. In such an embodiment, additional LPDC splitters 14 may be required as a function of the distance between the related or perspective DC powered devices 16, 18, 36, 38 to be powered by a LPDC splitter.

The distance between each LPDC splitter 14 and the HPDC source 12 may also be a factor in the LPDC splitter 14 number calculation. The method 50 may determine the maximum or furthest distance permitted between the HPDC source 12 and each LPDC splitter 14 and require one or more additional LPDC splitters 14 as function of the determined distance (based on local or national electrical codes, economical, wiring, or site topology). The method 50 may then deploy and couple the LPDC splitters 14 to the HPDC source 12 or other LPDC splitters 14 as a function of the determined number of LPDC splitters, their respective distance from each other and to the perspective DC powered devices for the LPDC splitter 14 (activity 58). The method 50 may then couple the LPDC splitter 14 to the perspective DC powered devices (activity 62).

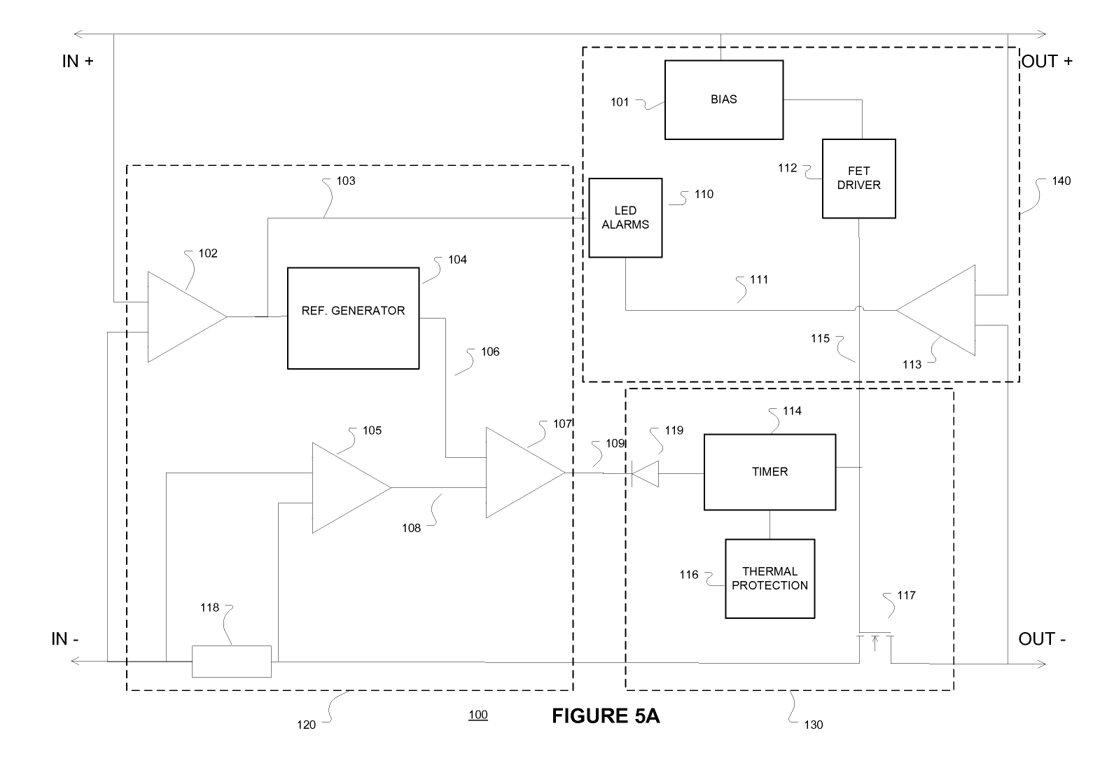

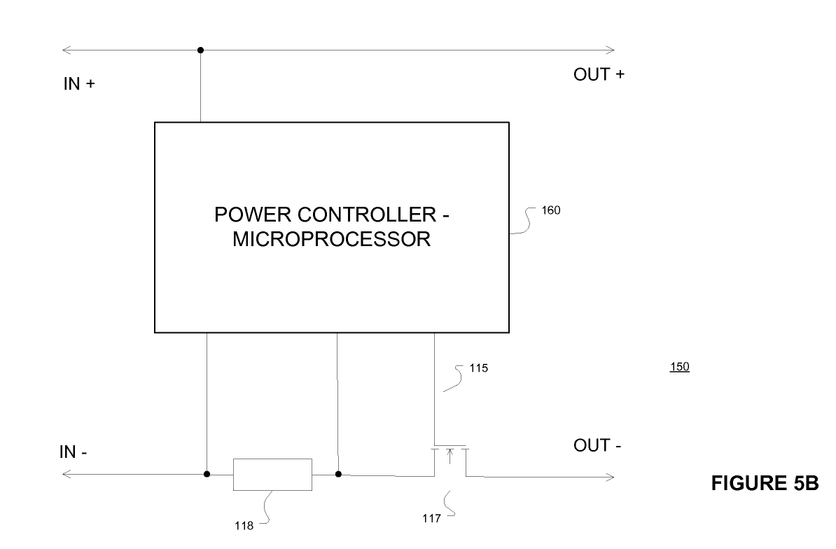

FIG. 5A is a block diagram of a LPDC splitter module 100 according to various embodiments. The module 100 includes a bias module 101, an input voltage amplifier module 102, a reference generator module 104, a current sense amplifier module 105, a current limit amplifier module 107, an LED alarm block module 110, a field-effect transistor (FET) driver module 112, an output voltage amplifier module 113, a timer module 114, a thermal protection device module 116, a metal-oxide-semiconductor field-effect transistor (MOSFET) Q1 (n-type) module 117, a resistor module 118, and a diode module 119. In an embodiment, the input voltage amplifier module 102, the reference generator module 104, the current sense amplifier module 105, the current limit amplifier module 107, and the resistor module 118 comprise a power control module 120. The bias module 101, LED alarm block module 110, FET driver module 112, and output voltage amplifier module 113 comprise an ancillary module 140. The diode module 119, the timer module 114, the thermal protection device module 116, and the MOSFET Q module 117 comprise a reference controlled output generation module 130.

In operation, the power control module 120 may receive an input signal and generate a reference signal 109. The ancillary module 140 generates a voltage reference signal 115 based on a bias signal and generates LED alarms and status. The reference controlled output generation module 130 receives the reference signal 109 and the voltage reference signal 115 to generate a power limited output signal across the output terminals OUT+, OUT−. In an embodiment, the reference signal 109 is modulated to limit the output signal power based on one or more electrical regulatory standards.

In an embodiment, an input voltage across terminals IN+, IN− is sensed by the input voltage amplifier module 102. The input voltage amplifier module generates a reference voltage 103. The reference generator module 104 receives the reference voltage 103, determines the input voltage range, and sets a reference voltage signal 106 for the current limit amplifier module 107. In an embodiment, the reference voltage 106 is set to one of two values as a function of the sensed voltage (as described below) based on the power limitations set for the lower-limited-power DC splitter module 100.

As noted above, a LPDC splitter 14 may have a limited power output based on one or more standards established by one or more electrical regulatory groups including the NEC. In an embodiment, the splitter module 100 may be configured to meet the NEC requirements for a Class 2 circuit where: a) for output voltages up to 20V, the maximum current is be limited to 5 A (100 Watt maximum for 20V output signal) and b) for output voltages between 20V and 60V, the maximum power is limited to 100 W. Accordingly, in an embodiment an output signal at 12V, has a 5 A current and power limitation of 60 W and an output signal at 24V has a power limitation of 100 W (and current effectively 4.15 A. current limit.)

In another embodiment, the reference voltage 106 is set to a range of values based on the measured voltage and one or more electrical codes or desired maximum power or current. For a device having a Class 2 circuit the ampere is limited to 5 for voltages up to 20 volts and the power is limited to 100 watts for voltages greater than 20 volts. Accordingly, the reference voltage 106 may be linearly related to the measured voltage where the maximum power is limited to the measured voltage times 5 amperes for measured voltages less than 20 volts. Otherwise the reference voltage 106 may be linearly related to a maximum power (100 watts in an embodiment) divided the measured voltage value.

In an embodiment, the current passing through the LPDC splitter module 100 may be determined by measuring voltage across a resistor 118. The current sense amplifier 105 amplifies the voltage across the resistor module 118 which is linearly related to the LPDC splitter module 100 output current. The current sense amplifier signal 108 (linearly related to the splitter module 100 output current) is one of two inputs to the current limit amplifier module 107. The reference generator module 104 provides the other input signal 106. The current limit amplifier module 107 effectively compares the voltage reference signal 106 to the current sense amplifier 105 output reference 108 to generate an output level control signal 109.

The timer 114 receives the control signal 109 and may set a timer when the signal 108 is greater than the signal 106 (and exceeds the barrier voltage of the diode module 119), which may indicate that the effective splitter 100 module power output level exceeds a desired maximum (such as that set by an electric regulatory code). The timer 114 may also effectively reduce the output signal level of the output generation module 130. The timer 114 may reduce the output signal level by reducing the gate voltage 115 of the MOSFET, Q1 117.

In an embodiment when the timer module 114 detects a power overload (beyond desired limits) exists for more than a predetermined time interval (250 ms in one embodiment), the timer module 114 may effectively turn off the output signal or power by removing the gate voltage to the MOSFET Q1 (117). The timer module 114 may after a second predetermined interval (15 seconds in an embodiment), allow a power generation signal to the gate via line 115. The timer module 114 may turn off the output signal 115 again if an overload is detected after the reset. The thermal protection block module 116 may generate a voltage that is related to the MOSFET Q1 117 operating temperature. In an embodiment, the timer module 114 may reduce the power level output or turn off the output for a predetermined time interval as a function of the measured temperature (as indicated by the thermal protection device module 116 signal.)

As noted above the ancillary module 140 may include the bias module 101, the LED alarm block module 110, the FET driver module 112, and the output voltage amplifier module 113. The bias module 101 may produce a low voltage level signal for use by the FET driver module 112. As known to one skilled in the art the FET driver module 112 may provide an appropriate drive voltage to the MOSFET, Q1 module 117. The LED alarm module 110 may monitor the reference signal 103 generated by the input voltage amplifier module 102 and a reference signal 111 generated by the output voltage amplifier module 113 and determine when the splitter 100 output voltage is within or outside predetermined limits. One or more LEDs may illuminate to show the status of the output voltage.

Any of the components previously described can be implemented in a number of ways, including embodiments in software. Thus, the HPDC source 12, LPDC splitter 14, 34, SSL fixtures 14, 16, 36, 38, power control module 120, reference controlled output generator module 130, ancillary module 140, the bias module 101, the input voltage amplifier 102 module the reference generator module 104, the current sense amplifier module 105, the current limit amplifier module 107, the LED alarm module 110, the field-effect transistor (FET) driver module 112, the output voltage amplifier module 113, the timer module 114, the thermal protection device module 116, the metal-oxide-semiconductor field-effect transistor (MOSFET) Q1 (n-type) 117 module, and the resistor module 118 may be characterized as “modules” herein.

The modules may include hardware circuits, single- or multi-processor circuits, memory circuits, software program modules and objects, firmware, and combinations thereof, as desired by the architect of the HPLDC source 12, LPDC 14, 34 and as appropriate for particular implementations of various embodiments. For example, in an embodiment of a LPDC splitter 150 may include a power controller microprocessor 160. The microprocessor 160 may measure the voltage across the resistor 118, monitor the voltage across the LPDC splitter 150, and control the MOSFET 117 gate voltage 115 to regulate the LPDC splitter 150 power level as explained above.

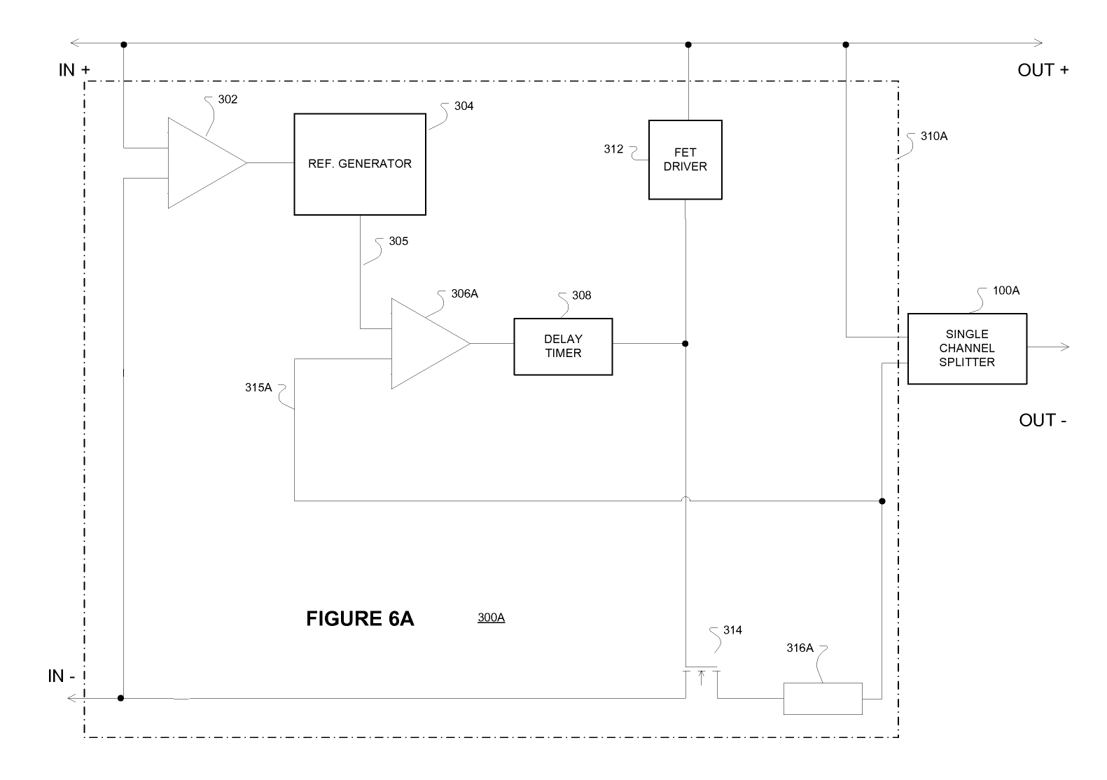

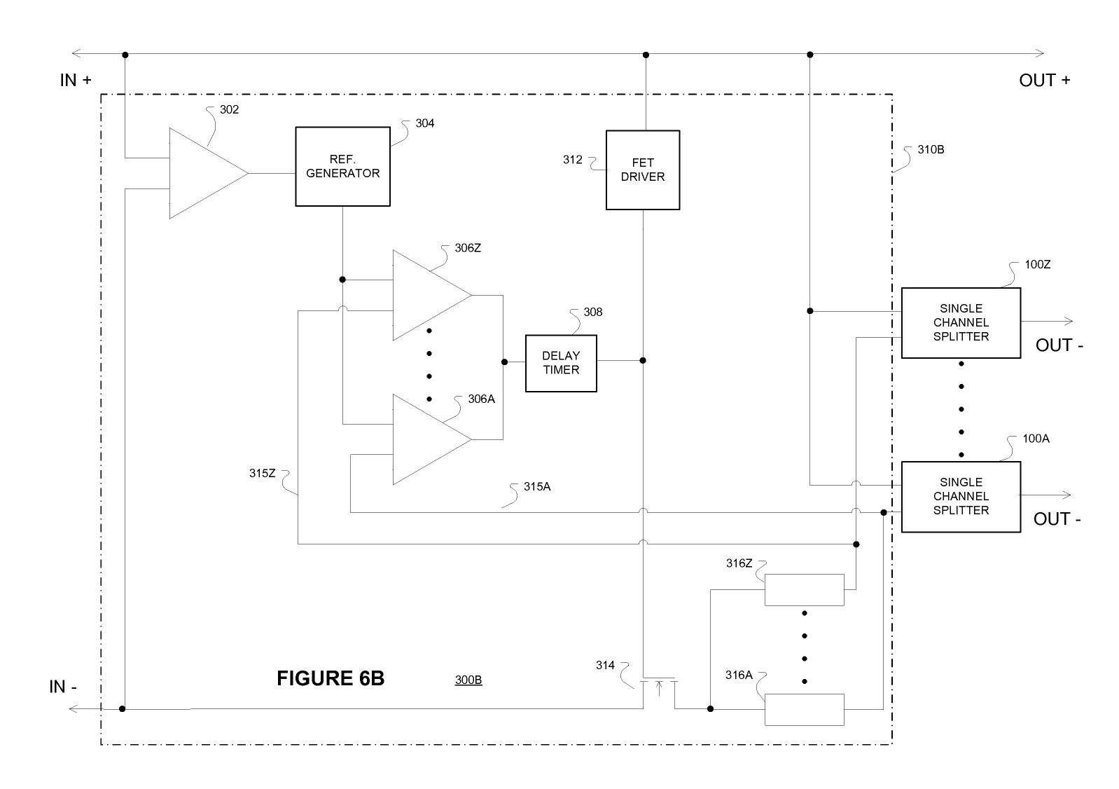

In an embodiment a secondary current, voltage, or power overload mechanism, circuitry or module may be desired. FIG. 6A is a block diagram of a LPDC splitter module 300A including a secondary current, voltage, or power overload circuitry. The module 300A includes a plurality of single channel LPDC splitters 100A to 100Z, an input voltage amplifier module 302, a reference generator module 304, a current limit amplifier module 306A, a delay timer 308, a field-effect transistor (FET) driver module 312, a metal-oxide-semiconductor field-effect transistor (MOSFET) Q1 (n-type) module 314, and a resistor module 316A. In an embodiment, the input voltage amplifier module 302, a reference generator module 304, a current limit amplifier module 306A, a delay timer 308, a field-effect transistor (FET) driver module 312, a metal-oxide-semiconductor field-effect transistor (MOSFET) Q1 (n-type) module 314, and a resistor module 316A comprise a secondary overload control module 310A to detect and prevent overloads according to the respective standards.

As described above, the input voltage amplifier module 302 senses the voltage across the input signal and the reference generator module 304 generate a reference signal 305 based on the sensed voltage and desired limits (based on current, voltage, or wattage limits). The current provided to the single channel splitter 100A is sensed via the resistor 316A and provided as an input signal 315A to the current limit amplifier module 306A. When current sensed across the resistor module 316A exceeds the reference level signal 305, the delay timer module 308 may immediately or after a predetermined delay (250 ms in an embodiment) may reduce or shutdown the gate signal to the MOSFET module 314 to limit or prevent overload signals to the single channel splitter 100A. The single channel splitter 100A may internally limit current, voltage, or wattage via the circuitry described above. The secondary control module 310A may also limit current, voltage, or wattage based on one or more standards. The secondary control module 310A may be incorporated in a single or multiple components including a microprocessor or Application Specific Integrated Circuit (ASIC).

FIG. 6B is a block diagram of another LPDC splitter module 300B including a secondary current, voltage, or power overload circuitry 310B. The module 300B includes a plurality of single channel LPDC splitters 100A to 100Z, an input voltage amplifier module 302, a reference generator module 304, a plurality of current limit amplifier module 306A to 306Z, a delay timer 308, a field-effect transistor (FET) driver module 312, a metal-oxide-semiconductor field-effect transistor (MOSFET) Q1 (n-type) module 314, and a plurality of resistor modules 316A to 316Z. In an embodiment, the input voltage amplifier module 302, a reference generator module 304, the plurality of current limit amplifier modules 306A to 306Z, a delay timer 308, a field-effect transistor (FET) driver module 312, a metal-oxide-semiconductor field-effect transistor (MOSFET) Q1 (n-type) module 314, and the plurality of resistor modules 316A to 316Z comprise a secondary overload control module 310B to detect and prevent overloads for each of the plurality of single channel splitter 100A to 100Z according to the respective standards.

As described above, the input voltage amplifier module 302 senses the voltage across the input signal and the reference generator module 304 generate a reference signal 305 based on the sensed voltage and desired limits (based on current, voltage, or wattage limits). The current provided to each single channel splitter 100A to 100Z is sensed via a resistor 316A to 316Z and provided as an input signal 315A to 315Z to a current limit amplifier module 306A to 306Z. When current sensed across a resistor module 316A to 316Z exceeds the reference level signal 305, the delay timer module 308 may immediately or after a predetermined delay (250 ms in an embodiment) may reduce or shutdown the gate signal to the MOSFET module 314 to limit or prevent overload signals to all single channel splitters 100A to 100Z. Each single channel splitter 100A to 100Z may internally limit current, voltage, or wattage via the circuitry described above. The secondary control module 310B may also limit current, voltage, or wattage based on one or more standards. The secondary control module 310B may be incorporated in a single or multiple components including a microprocessor or Application Specific Integrated Circuit (ASIC).

The apparatus and systems of various embodiments may be useful in applications other than generating DC signals. They are not intended to serve as a complete description of all the elements and features of apparatus and systems that might make use of the structures described herein.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 6 below.

FIG. 6 is a block diagram of an article 250 according to various embodiments of the invention. Examples of such embodiments may comprise a computer, a memory system, a magnetic or optical disk, some other storage device, or any type of electronic device or system. The article 250 may include one or more processor(s) 252 coupled to a machine-accessible medium such as a memory 254 (e.g., a memory including electrical, optical, or electromagnetic elements). The medium may contain associated information 256 (e.g., computer program instructions, data, or both) which, when accessed, results in a machine (e.g., the processor(s) 252) performing the activities previously described.

Although the inventive concept may include embodiments described in the exemplary context of one or more electrical standards, the claims are not so limited. Additional information regarding the NEC standards and other electrical standards may be found in common literature available to one of skill in the art.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A direct current (DC) splitting module to provide a controlled DC signal to a plurality of DC powered devices, including:
a first power control module to receive an input DC signal, determine the voltage level of the input DC power signal, and generate a first reference signal;
a first reference controlled output generator module to generate an intermediate DC signal based on the first reference signal and a first predetermined maximum of one of a power and a current level of the intermediate DC signal;
a second power control module to receive the intermediate DC signal, determine the voltage level of the intermediate DC signal, and generate a second reference signal;
a second reference controlled output generator module to generate the controlled DC signal based on the second reference signal and a second predetermined maximum one of a power and a current level of the controlled DC signal.

2. The DC splitting module of claim 1, wherein the second reference controlled output generator module generates the controlled DC signal with a fixed output voltage level where the output voltage level varies as a function of the intermediate DC signal voltage level.

3. The DC splitting module of claim 2, wherein the first power control module generates a first control signal representing a differential between the first predetermined maximum and the determined one of the power and the current level of the intermediate DC signal.

4. The DC splitting module of claim 3, wherein the first reference controlled output generator module reduces one of the power and the current level of the intermediate DC signal as a function of the first control signal.

5. The DC splitting module of claim 3, wherein the first reference controlled output generator module reduces one of the power and the current level of the intermediate DC signal to about zero as a function of the first control signal.

6. The DC limited power splitting module of claim 3, wherein the first reference controlled output generator module reduces one of the power and the current level of the intermediate DC signal to about zero as a function of the first control signal and time.

7. The DC splitting module of claim 1, wherein the second power control module generates a second control signal representing a differential between the second predetermined maximum and the determined one of the power and the current level of the controlled DC signal.

8. The DC splitting module of claim 7, wherein the second reference controlled output generator module reduces one of the power and the current level of controlled DC signal as a function of the second control signal.

9. The DC splitting module of claim 7, wherein the second reference controlled output generator module reduces one of the power and the current level of controlled DC signal to about zero as a function of the second control signal.

10. The DC limited power splitting module of claim 7, wherein the second reference controlled output generator module reduces one of the power and the current level of controlled DC signal to about zero as a function of the second control signal and time.

11. A method to provide a controlled DC signal to a plurality of DC powered devices, including:
at a first power control module, receiving an input DC signal, determining the voltage level of the input DC power signal, and generating a first reference signal;
at a first reference controlled output generator module, generating an intermediate DC signal based on the first reference signal and a first predetermined maximum of one of a power and a current level of the intermediate DC signal;
at a second power control module, receiving the intermediate DC signal, determining the voltage level of the intermediate DC signal, and generating a second reference signal;
at a second reference controlled output generator module, generating the controlled DC signal based on the second reference signal and a second predetermined maximum one of a power and a current level of the controlled DC signal.

12. The method of claim 11, wherein at the second reference controlled output generator module, generating the controlled DC signal with a fixed output voltage level where the output voltage level varies as a function of the intermediate DC signal voltage level.

13. The method of claim 12, wherein at the first power control module, generating a first control signal representing a differential between the first predetermined maximum and the determined one of the power and the current level of the intermediate DC signal.

14. The method of claim 13, wherein at the first reference controlled output generator module, reducing one of the power and the current level of the intermediate DC signal as a function of the first control signal.

15. The method of claim 13, wherein at the first reference controlled output generator module, reducing one of the power and the current level of the intermediate DC signal to about zero as a function of the first control signal.

16. The method of claim 13, wherein at the first reference controlled output generator module, reducing one of the power and the current level of the intermediate DC signal to about zero as a function of the first control signal and time.

17. The method of claim 11, wherein at the second power control module, generating a second control signal representing a differential between the second predetermined maximum and the determined one of the power and the current level of the controlled DC signal.

18. The method of claim 17, wherein at the second reference controlled output generator module, reducing one of the power and the current level of controlled DC signal as a function of the second control signal.

19. The method of claim 17, wherein at the second reference controlled output generator module, reducing one of the power and the current level of controlled DC signal to about zero as a function of the second control signal.

20. The DC limited power splitting module of claim 17, wherein at the second reference controlled output generator module, reducing one of the power and the current level of controlled DC signal to about zero as a function of the second control signal and time.

21. A direct current (DC) splitting module to provide a controlled DC signal to a plurality of DC powered devices, including:
a power control module to receive an input DC signal, determine the voltage level of the input DC power signal, and generate a control signal representing a differential between a first predetermined maximum one of a power and a current level of the controlled DC signal and the determined one of the power and the current level of the controlled DC signal;
a reference controlled output generator module to generate the controlled DC signal based on the predetermined maximum one of a power and a current level of the controlled DC signal and reduce one of the power and the current level of controlled DC signal as a function of the control signal.

22. The DC splitting module of claim 21, wherein the reference controlled output generator module generates the controlled DC signal with a fixed output voltage level where the output voltage level varies as a function of the input DC signal voltage level.

23. The DC splitting module of claim 21, wherein the reference controlled output generator module reduces one of the power and the current level of controlled DC signal to about zero as a function of the control signal.

24. The DC limited power splitting module of claim 21, wherein the reference controlled output generator module reduces one of the power and the current level of controlled DC signal to about zero as a function of the control signal and time.

25. A method of providing a controlled DC signal to a plurality of DC powered devices, including:
at a power control module, receiving an input DC signal, determining the voltage level of the input DC power signal, and generating a control signal representing a differential between a first predetermined maximum one of a power and a current level of the controlled DC signal and the determined one of the power and the current level of the controlled DC signal;
at a reference controlled output generator module, generating the controlled DC signal based on the predetermined maximum one of a power and a current level of the controlled DC signal and reducing one of the power and the current level of controlled DC signal as a function of the control signal.

26. The method of claim 25, wherein at the reference controlled output generator module, generating the controlled DC signal with a fixed output voltage level where the output voltage level varies as a function of the input DC signal voltage level.

27. The method of claim 25, wherein at the reference controlled output generator module, reducing one of the power and the current level of controlled DC signal to about zero as a function of the control signal.

28. The method of claim 25, wherein at the reference controlled output generator module, reducing one of the power and the current level of controlled DC signal to about zero as a function of the control signal and time.
